(19) United States
(12) Patent Application Publication
(10) Pub. No.: US 2022/0403152 A1
(43) Pub. Date: Dec. 22, 2022

(54) POROUS POLYMER POWDER, ITS COMPOSITION, ITS USE AND COMPOSITION COMPRISING IT

(71) Applicant: Arkema France, Colombes (FR)

(72) Inventors: Aline Couffin, Lacq (FR); Philippe Hajji, Pierre-Benite Cedex (FR); Alexandre Vermogen, Pierre-Benite Cedex (FR); Elisabeth Bay, Lacq (FR); Jean-Claude Saint-Martin, Lacq (FR); Vinciane Chartois, Pierre-Benite Cedex (FR)

(21) Appl. No.: 17/777,292

(22) PCT Filed: Nov. 30, 2020
(86) PCT No.: PCT/EP2020/083953

§ 371 Date: May 17, 2022

(30) Foreign Application Priority Data
Nov. 29, 2019 (FR) FR1913525

(51) Int. Cl. C08L 33/10

(52) U.S. Cl. CPC C08L 33/10; C08L 2207/53

(57) ABSTRACT

The present invention relates to a polymeric composition in form of porous polymer powder, its composition and its use. In particular, the present invention relates to a porous polymer powder comprising polymer in form of polymeric particles made by a multistage process. The present invention relates also to the use of the porous polymer powder and a composition comprising it.

### FIELD OF THE INVENTION

The present invention relates to a polymeric composition in form of porous polymer powder, its composition and its use.

In particular, the present invention relates to a porous polymer powder comprising polymer in form of polymeric particles made by a multistage process.

The present invention relates also to the use of the porous polymer powder and a composition comprising is.

### Technical Problem

Polymers are widely used also as additives in polymer compositions. These polymer additives are usually added as granulate or as powder, either to solid polymers, or to molten polymers or to liquid resins or to liquid compositions.

One class of polymeric additives are processing aids, another one are polymeric impact modifiers.

Usually polymeric impact modifiers in form of core-shell particles are made by a multistage process, with at least one stage comprising a rubber like polymer. Afterwards these particles are incorporated in the polymers or polymer compositions, in order to increase their impact resistance.

Another class of kind of polymeric additives are for example polymeric particles for light scattering or diffusion of polymeric matrixes or for having surface roughness or gloss of polymeric surfaces.

Usually scattering polymeric particles are made of polymers, which are crosslinked at some extent, in order to preserve the particle form.

Thermosetting polymers consist of crosslinked three-dimensional structures. The crosslinking is obtained by curing reactive groups inside the so-called prepolymer. Curing for example can be obtained by heating the polymer chains or prepolymer in order to crosslink and harden the material permanently.

Thermoplastic polymers consist of linear or branched polymers, which are usually not crosslinked.

However these kind of core-shell particles or scattering particles are not easy to disperse or fast to disperse in all kind of resins or polymers or precursors to polymers, especially for example in liquid epoxy resins or liquid monomers or other liquid polymeric precursors.

A good homogenous and fast dispersion is necessary for having satisfying impact performance or scattering performance in the final polymeric composition.

An objective of the present invention is to propose a polymeric composition in form of a polymer powder which is rapidly and easily dispersible, especially in liquid resins as for example precursors for thermoset polymers or thermoplastic polymers as respectively for instance in epoxy resins or in (meth)acrylic monomers.

An additional objective of the present invention is to propose a polymeric composition in form of a dry polymer powder which is easily dispersible especially in liquid resins as for example epoxy resins or (meth)acrylic monomers.

Still another objective of the present invention is the use of a polymeric composition in form of a polymer powder for preparing a liquid composition comprising precursors for thermoset polymers or thermoplastic polymers as liquid reactive epoxy resins or (meth)acrylic monomers in which is dispersed the polymeric composition.

Still another objective is to reduce the time of dispersing a polymer powder in a liquid composition.

Still an additional objective is to propose an impact modifier in form of a polymer powder which is rapidly and easily dispersible, especially in liquid resins as for example precursors for thermoset polymers or thermoplastic polymers as respectively for instance epoxy resins or (meth)acrylic monomers.

### BACKGROUND OF THE INVENTION

### Prior Art

The document US2004/0147668 discloses an acrylic polymer powder, an acrylic sol and molding. The acrylic polymer powder has an average size of 5 μm to 10 μm and void volume on the voids having a pore diameter of 1 μm or more and is 0.9 ml/g or less.

The document EP2196479 discloses a vinylidene fluoride polymer powder and the use thereof. The polymer powder is produced by supercritical suspension polymerization and the volume of the pores having a pore diameter of 0.03 μm to 1.0 μm as measured by a mercury porosimeter is 70 vol % to 93 vol % of total pore volume.

The document WO2017/121749 discloses a liquid composition comprising a multistage polymer. In particular a liquid composition comprising a monomer, a (meth)acrylic polymer and a multistage polymer is disclosed.

None of the prior art documents discloses a polymeric composition in form of powder having a porosity expressed in total intruded volume of at last 1.2 ml/g as measured by mercury intrusion.

### BRIEF DESCRIPTION OF THE INVENTION

Surprisingly it has been found that a polymeric composition in form of a porous polymeric powder POW1 can be easily and fast dispersed in other polymers, liquid resins and/or monomers, if the total intruded volume of the powder is at least 1.2 ml/g as measured by mercury porosimetry.

Surprisingly it has also been found that a polymeric composition in form of a porous polymeric powder POW1 comprising polymeric particles can be easily and fast dispersed in other polymers and liquid resins, if the total intruded volume of the powder is at least 1.2 ml/g as measured by mercury porosimetry.

Surprisingly it has additionally been found that a polymeric composition in form of a porous polymeric powder POW1 comprising polymeric particles can be easily and fast dispersed homogenously in other polymers and liquid resins for giving a satisfying impact resistance, if the total intruded volume of the powder is at least 1.2 ml/g as measured by mercury porosimetry.

Surprisingly it has also been found that a process for manufacturing a liquid polymer composition LPC1 comprising the steps of
a) providing a polymeric composition in form of a porous polymer powder POW1 having total intruded volume of at least 1.2 ml/g as measured by mercury porosimetry,
b) bringing into contact the polymeric composition with a liquid composition LC1,
   yields to a liquid polymer composition where the polymeric composition POW1 is homogenously and fastly dispersed in the liquid composition LC1.

Surprisingly it has also been found that a polymeric composition in form of a porous polymer powder POW1 having total intruded volume of at least 1.2 ml/g as measured by mercury porosimetry and can be used to prepare a liquid polymeric compositions

Surprisingly it has also been found that a polymeric composition in form of a porous polymer powder POW1 having total intruded volume of at least 1.2 ml/g as measured by mercury porosimetry can be used to reduce the time of dispersing porous polymer powder POW1 for obtaining liquid polymeric compositions.

Surprisingly it has additionally been found a process to reduce the time of dispersing a polymeric composition in a liquid composition comprising the steps of:
a) providing a polymeric composition in form of a porous polymer powder POW1 having total intruded volume of at least 1.2 ml/g as measured by mercury porosimetry,
b) bringing into contact the polymeric composition with a liquid composition LC1,
   is faster than the same process using a polymeric composition in form of a polymer powder having a lower total intruded volume as measured by mercury porosimetry.

### DETAILED DESCRIPTION OF THE INVENTION

According to a first aspect, the present invention relates to a polymeric composition in form of a porous polymer powder POW1 having total intruded volume of at least 1.2 ml/g as measured by mercury porosimetry.

According to a second aspect, the present invention relates to a process for manufacturing a liquid polymer composition LCP1 comprising the steps of
a) providing polymeric composition in form of a porous polymer powder POW1 total intruded volume of at least 1.2 ml/g as measured by mercury porosimetry,
b) bringing into contact said polymeric composition in form of a porous polymer powder POW1 with a liquid composition LC1.

In a third aspect the present invention relates to the use of a polymeric composition in form of a porous polymer powder POW1 having total intruded volume of at least 1.2 ml/g as measured by mercury porosimetry, to reduce the dispersion time of said polymer powder POW1 in a liquid composition LC1.

In a fourth aspect the present invention relates to a process to reduce the dispersion time of a polymeric composition, characterized that the polymeric composition is in form of a polymer powder POW1 having total intruded volume of at least 1.2 ml/g as measured by mercury porosimetry in polymeric composition.

By the term “polymer powder” as used is denoted a polymer in form of a powder comprising powder grains in the range of at least 1 μm obtained by agglomeration of primary polymer particles comprising polymer or polymers, said primary polymer particles are in the nanometer range.

By the term “primary particle” as used is denoted a spherical polymer comprising particle in the nanometer range. Preferably the primary particle has a weight average particle size between 50 nm and 1000 nm.

By the term “particle size” as used is denoted the volume average diameter of the particle.

By the term “thermoplastic polymer” as used is denoted a polymer that turns to a liquid or becomes more liquid or less viscous when heated and that can take on new shapes by the application of heat and pressure.

By the term “thermosetting polymer” as used is denoted a prepolymer in a soft, solid or viscous state that changes irreversibly into an infusible, insoluble polymer network by curing.

By the term “polymer composite” as used is denoted a multicomponent material comprising multiple different phase domains in which at least one type of phase domain is a continuous phase and in which at least one component is a polymer.

By the term “copolymer” as used is denoted that the polymer consists of at least two different monomers.

By “multistage polymer” as used is denoted a polymer formed in sequential fashion by a multi-stage polymerization process. Preferred is a multi-stage emulsion polymerization process in which the first polymer is a first-stage polymer and the second polymer is a second-stage polymer, i.e., the second polymer is formed by emulsion polymerization in the presence of the first emulsion polymer, with at least two stages that are different in composition.

By the term “(meth)acrylic” as used is denoted all kind of acrylic and methacrylic monomers.

By the term “(meth)acrylic polymer” as used is denoted that the (meth)acrylic) polymer comprises essentially polymers comprising (meth)acrylic monomers that make up 50 wt % or more of the (meth)acrylic polymer.

By the term “dry” as used is denoted that the ratio of residual water is less than 1 wt %.

By saying that a range from x to y in the present invention, it is meant that the upper and lower limit of this range are included, equivalent to at least x and up to y.

By saying that a range is between x and y in the present invention, it is meant that the upper and lower limit of this range are excluded, equivalent to more than x and less than y.

By the term “total intruded volume” as used is denoted the total volume intruded by liquid mercury according to ISO 15901-1:2016. This volume is cummulated and the analysis results show cumulated intruded volume in ml/g (cm³/g) as function of the applied pressure or the pore diameter. The total intruded volume is the volume intruded at the maximal applied pressure, which corresponds also to the smallest pores.

By the term “incremental intrusion” as used is denoted the volume intruded in ml/g between two certain pressures or two pore sizes. This incremental intrusion can also be expressed relatively to the total intruded volume in vol %.

With easily dispersed in liquid resins is meant that a homogenous dispersion is obtained. The distribution of the polymeric composition is not homogenous if separation takes place after initial homogenization.

With fast dispersed in liquid resins is meant that a homogeneous dispersion is obtained much faster than with a polymeric composition not having the minimal required porosity.

The polymeric composition according to the invention is in form of larger polymer particles: a porous polymer powder POW1 having total intruded volume or total cumulative intrusion of at least 1.2 ml/g as measured by mercury porosimetry. The polymer powder POW1 particles comprises agglomerated primary polymer particles PAR1.

With regard to the polymer powder POW1 of the invention, it has a volume median particle size D50 between 1 μm and 700 μm. Preferably the volume median particle size of the polymer powder is between 10 μm and 600 μm, more preferably between 15 μm and 550 μm and advantageously between 20 μm and 500 μm.

The D10 of the particle size distribution in volume is at least 7 μm and preferably 10 μm, more preferably 15 μm.

The D90 of the particle size distribution in volume is at most 1000 μm and preferably 950 μm, more preferably at most 900 μm and even more preferably at most 800 μm.

The porosity of the polymer powder POW1 is expressed as total intruded volume or total cumulative intrusion (cumulative intruded volume) in millilitre (ml) of mercury per mass (g) of said polymer powder POW1. This is measured according to the norm ISO 15901-1: Evaluation of pore size distribution and porosity of solid materials by mercury porosity and gas adsorption—Part 1: mercury porosity. The porous polymer powder POW1 of the invention has a total intruded volume or total cumulative intrusion of at least 1.2 ml/g, preferably 1.25 ml/g, more preferably 1.3 ml/g, even more preferably 1.35 ml/g. The total cumulative intrusion is taken into account until a pore size diameter of 0.005 μm. Preferably the total intruded volume or total cumulative intrusion is taken into account between a pore size diameter of 100 μm and 0.005 μm or a pressure between 0.01 MPa and 400 MPa.

The porous polymer powder POW1 of the invention has a total intruded volume or total cumulative intrusion of at most 10 ml/g. Preferably the total intruded volume is at most 8 ml/g, more preferably at most 7 ml/g, even more preferably at most 6 ml/g, advantageously at most 5 ml/g and most advantageously at most 4 ml/g.

The respective upper and lower limits given in the previous two paragraphs for total intruded volume or total cumulative intrusion of the porous polymer powder POW1 of the invention, can be combined in any combinations of one upper and one lower limit.

Preferably the porous polymer powder POW1 of the invention has a total intruded volume or total cumulative intrusion between 1.2 ml/g and 10 ml/g, more preferably between 1.25 ml/g and 8 ml/g, even more preferably between 1.3 ml/g and 7 ml/g, advantageously between 1.35 ml/g and 6 ml/g, more advantageously between 1.35 ml/g and 5 ml/g and most advantageously between 1.35 ml/g and 4 ml/g.

The incremental intrusion (incremental intruded volume) is the volume between two certain pore diameters. The incremental intrusion can be expressed as an absolute value also in ml/g or as a relative value es percentage of total intruded volume or total cumulative intrusion (which is taken into account between a pore size diameter of 100 μm and 0.005 μm).

Preferably the porous polymer powder POW1 of the invention has a cumulative intrusion for a pore size above 10 μm (larger than 10 μm) of at least 0.9 ml/g, more preferably at least 1 ml/g.

Preferably the porous polymer powder POW1 of the invention has a relative incremental intrusion for a pore size above 10 μm (larger than 10 μm) of at most 85%, more preferably at most 82% and even more preferably at most 80%.

Preferably the porous polymer powder POW1 of the invention has an incremental intrusion between a pore size from 10 μm to 1 μm of at least 0.1 ml/g, more preferably at least 0.12 ml/g and even more preferably at least 0.15 ml/g.

Preferably the porous polymer powder POW1 of the invention has a relative incremental intrusion between a pore size from 10 μm to 1 μm of at least 5%, more preferably at least 8% and even more preferably at least 10%.

Preferably the porous polymer powder POW1 of the invention has an incremental intrusion between a pore size from 10 μm to 0.1 μm of at least 0.15 ml/g, more preferably at least 0.2 ml/g and even more preferably at least 0.25 ml/g.

Preferably the porous polymer powder POW1 of the invention has a relative incremental intrusion between a pore size from 10 μm to 0.1 μm of at least 10%, more preferably at least 15% and even more preferably at least 20%.

Preferably the porous polymer powder POW1 of the invention has an incremental intrusion between a pore size from 1 μm to 0.1 μm of at least 0.05 ml/g, more preferably at least 0.06 ml/g and even more preferably at least 0.07 ml/g.

Preferably the porous polymer powder POW1 of the invention has a relative incremental intrusion between a pore size from fpm to 0.1 μm of at least 5%, more preferably at least 7.5% and even more preferably at least 10%.

The apparent bulk density of the polymer powder POW1 is less than 0.60 g/cm³. Preferably the apparent bulk density is less than 0.45 g/cm³, more preferably less than 0.43 g/cm³, and even more preferably less than 0.41 g/cm³.

The apparent bulk density of the polymer powder POW1 is more than 0.1 g/cm³. Preferably the apparent bulk density is more than 0.11 g/cm³, more preferably is more than 0.12 g/cm³, even more preferably more than 0.13 g/cm³.

The apparent bulk density of the polymer powder POW1 is between 0.1 g/cm³ and 0.60 g/cm³. Preferably, the apparent bulk density of the polymer powder POW1 is between 0.12 g/cm³ and 0.45 g/cm³.

The polymer powder POW1 of the invention comprises polymeric particles PAR1. The polymeric particles PAR1 make up at least 50 wt % of the polymer powder composition POW1. More preferably the polymeric particles PAR1 make up at least 60 wt %, still more preferably at least 70 wt % of the polymer powder composition POW1.

In one preferred embodiment, the polymer powder POW1 of the invention consists only of polymeric particles PAR1.

In another preferred embodiment, the polymer powder POW1 of the invention comprises at least 80 wt % of polymeric particles PAR1.

The polymeric particles PAR1 can be one kind of particles or a mixture of different kind of particles PAR1a and PAR1b. The difference between the different particles PAR1a and PAR1b, can be the particle size, the polymeric composition or the morphology of the particles or any combination of these three characteristics.

With regard to the polymeric particle PAR1 according to the invention, which is also called the primary particle, it has a weight average particle size (diameter) between 15 nm and 900 nm. Preferably, the weight average particle size of the polymer particle is between 40 nm and 800 nm, more preferably between 75 nm and 700 nm and advantageously between 30 nm and 500 nm. The primary polymer particles can be agglomerated giving the polymer powder POW1 of the invention.

The distribution of the particle size can be monodisperse or polydisperse, as long as the weight average particle size (diameter) between 15 nm and 900 nm.

In a first preferred embodiment the polymer powder POW1 comprises a multistage polymer MSP1 as polymeric particle PAR1. The multistage polymer MSP1 is advantageously in form of a core-shell particle, the polymeric particles PAR1.

In a second preferred embodiment the polymer powder POW1 comprises a polymer P1. The polymer P1 forms the polymeric particles PAR1.

In a third preferred embodiment the polymer powder POW1 comprises a multistage polymer MSP1 and a (meth)acrylic polymer MP1. In one embodiment the multistage polymer is in form of a core-shell particle, and the (meth)acrylic polymer MP1 is in form of a polymeric particle as well; a mixture of different particles PAR1a and PAR1b with a different polymeric composition and morphology. In another embodiment the (meth)acrylic polymer MP1 is part of the multistage polymer, the two together in polymeric particle PAR1.

The respective preferred embodiment of all the different characteristics of the porous polymer powder POW1 of the invention, can be combined.

With regard to the (meth)acrylic polymer MP1 of the third preferred embodiment the polymer powder POW1, it has a mass average molecular weight Mw of between 10 000 g/mol and 500 000 g/mol.

The (meth)acrylic polymer MP1 has a mass average molecular weight Mw of more than 10 000 g/mol, preferably more than 10 500 g/mol, more preferably more than 11 000 g/mol, still more preferably more than 12 000 g/mol, advantageously more than 13 000 g/mol, more advantageously more than 14 000 g/mol and still more advantageously more than 15 000 g/mol.

The (meth)acrylic polymer MP1 has a mass average molecular weight Mw below 500 000 g/mol, preferably below 450 000 g/mol, more preferably below 400 000 g/mol, still more preferably below 400 000 g/mol, advantageously below 350 000 g/mol, more advantageously below 300 000 g/mol and still more advantageously below 250 000 g/mol and most advantageously below 200 000 g/mol.

Preferably the mass average molecular weight Mw of the (meth)acrylic polymer MP1 is between 10 500 g/mol and 450 000 g/mol, more preferable between 11 000 g/mol and 400 000 g/mol and even more preferably between 12 000 g/mol and 350 000 g/mol advantageously between 13 000 g/mol and 300 000 g/mol, more advantageously between 14 000 g/mol and 250 000 g/mol and most advantageously between 15 000 g/mol and 200 000 g/mol.

In a first advantageously embodiment the mass average molecular weight Mw of the (meth)acrylic polymer MP1 is between 10 500 g/mol and 200 000 g/mol, more preferable between 11 000 g/mol and 190 000 g/mol and even more preferably between 12 000 g/mol and 180 000 g/mol advantageously between 13 000 g/mol and 150 000 g/mol, more advantageously between 14 000 g/mol and 135 000 g/mol and most advantageously between 15 000 g/mol and 120 000 g/mol.

In a second advantageously embodiment the mass average molecular weight Mw of the (meth)acrylic polymer MP1 is between 15 000 g/mol and 450 000 g/mol, more preferable between 16 000 g/mol and 400 000 g/mol and even more preferably between 17 000 g/mol and 350 000 g/mol advantageously between 18 000 g/mol and 300 000 g/mol, more advantageously between 19 000 g/mol and 250 000 g/mol and most advantageously between 20 000 g/mol and 200 000 g/mol.

Preferably the (meth)acrylic polymer MP1 is a copolymer comprising (meth)acrylic monomers. Still more preferably the (meth)acrylic polymer MP1 comprises at least 70 wt % monomers chosen from C1 to C12 alkyl (meth)acrylates. Advantageously the (meth)acrylic polymer MP1 comprises at least 80 wt % of monomers C1 to C4 alkyl methacrylate and/or C1 to C8 alkyl acrylate monomers.

Preferably the glass transition temperature Tg of the (meth)acrylic polymer MP1 is between 30° C. and 150° C. The glass transition temperature of the (meth)acrylic polymer MP1 is more preferably between 40° C. and 150° C., advantageously between 45° C. and 150° C. and more advantageously between 50° C. and 150° C.

The multistage polymer (MSP1) has a multilayer structure comprising at least one stage (SA1) comprising a polymer (A1) having a glass transition temperature below 10° C., at least one stage (SA2) comprising a polymer (A2) having a glass transition temperature over 60° C.

Preferably the stage (SA1) is the first stage of the at least two stages and the stage (SA2) comprising polymer (A2) is grafted on stage (SA1) comprising polymer (A1) or another optional intermediate layer.

In a further variation, there could also be another stage before stage (SA1), so that stage (SA1) would also be a kind of shell, for example on a seed.

In a first embodiment the polymer (A1) having a glass transition temperature below 10° C. comprises at least 50 wt % of polymeric units coming from alkyl acrylate and the stage (SA1) is the most inner layer of the multistage polymer (MSP1) or the polymer particle having the multilayer structure. In other words the stage (SA1) comprising the polymer (A1) is the core of the multistage polymer (MP1) or the polymer particle.

With regard to the polymer (A1) of the first preferred embodiment, it is a (meth) acrylic polymer comprising at least 50 wt % of polymeric units coming from acrylic monomers. Preferably 60 wt % and more preferably 70 wt % of the polymer (A1) are acrylic monomers.

The acrylic momonomer units in polymer (A1) comprises monomers chosen from C1 to C18 alkyl acrylates or mixtures thereof. More preferably the acrylic monomer units in polymer (A1) comprises monomers of C2 to C12 alkyl acrylic monomers or mixtures thereof Still more preferably acrylic monomer in polymer (A1) comprises monomers of C2 to C8 alkyl acrylic monomers or mixtures thereof.

The polymer (A1) can comprise a comonomer or comonomers which are copolymerizable with the acrylic monomer, as long as polymer (A1) is having a glass transition temperature of less than 10° C.

The comonomer or comonomers in polymer (A1) are preferably chosen from (meth)acrylic monomers and/or vinyl monomers.

Most preferably the acrylic or methacrylic comonomers of the polymer (A1) are chosen from methyl acrylate, propyl acrylate, isopropyl acrylate, butyl acrylate, tert-butyl acrylate, methyl methacrylate, ethyl methacrylate, butyl methacrylate and mixtures thereof, as long as polymer (A1) is having a glass transition temperature of less than 10° C.

In a specific embodiment the polymer (A1) is a homopolymer of butyl acrylate.

More preferably the glass transition temperature Tg of the polymer (A1) comprising at least 70 wt % of polymeric units coming from C2 to C8 alkyl acrylate is between −100° C. and 10° C., even more preferably between −80° C. and 0° C. and advantageously between −80° C. and −20° C. and more advantageously between −70° C. and −20° C.

In a second preferred embodiment the polymer (A1) having a glass transition temperature below 10° C. comprises at least 50 wt % of polymeric units coming from isoprene or butadiene and the stage (A) is the most inner layer of the polymer particle having the multilayer structure. In other words the stage (SA1) comprising the polymer (A1) is the core of the polymer particle.

By way of example, the polymer (A1) of the core of the second embodiment, mention may be made of isoprene homopolymers or butadiene homopolymers, isoprene-butadiene copolymers, copolymers of isoprene with at most 98 wt % of a vinyl monomer and copolymers of butadiene with at most 98 wt % of a vinyl monomer. The vinyl monomer may be styrene, an alkylstyrene, acrylonitrile, an alkyl (meth)acrylate, or butadiene or isoprene. In a preferred embodiment the core is a butadiene homopolymer.

More preferably the glass transition temperature Tg of the polymer (A1) comprising at least 50 wt % of polymeric units coming from isoprene or butadiene is between −100° C. and 10° C., even more preferably between −90° C. and 0° C., advantageously between −85° C. and 0° C. and most advantageously between −800° C. and −20° C.

In a third preferred embodiment the polymer (A1) is a silicone rubber based polymer. The silicone rubber for example is polydimethyl siloxane. More preferably the glass transition temperature Tg of the polymer (A1) of the second embodiment is between −150° C. and 0° C., even more preferably between −145° C. and −5° C., advantageously between −140° C. and −15° C. and more advantageously between −135° C. and −25° C.

With regard to the polymer (A2), mention may be made of homopolymers and copolymers comprising monomers with double bonds and/or vinyl monomers. Preferably, the polymer (A2) is a (meth) acrylic polymer.

Preferably the polymer (A2) comprises at least 70 wt % monomers chosen from C1 to C12 alkyl (meth)acrylates. Still more preferably the polymer (A2) comprises at least 80 wt % of monomers C1 to C4 alkyl methacrylate and/or C1 to C8 alkyl acrylate monomers.

Most preferably the acrylic or methacrylic monomers of the polymer (A2) are chosen from methyl acrylate, ethyl acrylate, methyl methacrylate, ethyl methacrylate, butyl methacrylate and mixtures thereof, as long as polymer (A2) is having a glass transition temperature of at least 60° C.

Advantageously the polymer (A2) comprises at least 70 wt % of monomer units coming from methyl methacrylate.

Preferably the glass transition temperature Tg of the polymer (A2) is between 60° C. and 150° C. The glass transition temperature of the polymer (A2) is more preferably between 80° C. and 150° C., advantageously between 90° C. and 150° C. and more advantageously between 100° C. and 150° C.

Preferably the polymer (A2) of the multistage polymer (MP1) is grafted on the polymer (A1) made in the previous stage.

In certain embodiments the polymer (A2) is crosslinked.

In one embodiment the polymer (A2) comprises a functional comonomer. The functional copolymer is chosen from acrylic or methacrylic acid, the amides derived from this acids, such as for example dimethylacrylamide, 2-methoxy-ethyl acrylate or methacrylate, 2-aminoethyl acrylate or methacrylate which are optionally quaternized, polyethylene glycol (meth) acrylates, water soluble vinyl monomers such as N-vinyl pyrrolidone or mixtures thereof. Preferably the polyethylene glycol group of polyethylene glycol (meth) acrylates has a molecular weight ranging from 400 g/mol to 10 000 g/mol.

With regard to the liquid composition LC1 to which is contacted with the porous polymer powder POW1 according to the invention in the in the process according to the second aspect of the invention, it is or comprises a precursor for a thermosetting polymer or a monomer of a thermoplastic polymer.

The viscosity of the liquid composition LC1 is between 0.5 mPas 1000 Pa*s at a temperature of 25° C. The viscosity is the dynamic viscosity.

The viscosity of the liquid polymer composition LCP1, prepared in the process according to the second aspect of the invention, is between 10 mPas 100 000 Pa*s at a temperature of 25° C. The viscosity is the dynamic viscosity.

For example the liquid composition LC1 can be chosen from compositions for preparing vinyl ester, unsaturated polyester or epoxy resin; or it can be for example a styrenic monomer or an (meth)arylic monomer, or a mixture thereof or a liquid composition comprising said monomers.

Preferably the porous polymer powder POW1 represents between 0.5 and 50 wt % of the liquid polymer composition LCP1.

The process to reduce the dispersion time comprises at least the step of providing a polymeric composition in form of a porous polymer powder POW1 having total intruded volume of at least 1.2 ml/g as measured by mercury porosimetry.

The process provides optionally also comprises the step of providing a precursor for a thermosetting polymer or a monomer of a thermoplastic polymer. Preferably, the precursor is liquid. More preferably the precursor has a viscosity between 0.5 mPas 1000 Pa*s at a temperature of 25° C. The viscosity is the dynamic viscosity.

The process to reduce the dispersion time optionally also comprises the step of bringing into contact the polymeric composition in form of a porous polymer powder POW1 and said precursor. Preferably between 0.5 parts by weight and 100 parts by weight of porous polymer powder POW1 are brought into contact for 100 parts by weight of said precursor.

The present invention relates also to the use of the polymer composition in form of the polymer powder according to the invention as an impact modifier in polymers, in order to obtain an impact modified polymer composition. Preferably the polymers are thermosetting polymers or its precursors or thermoplastic polymers or its precursors.

### [Methods of Evaluation]

Glass Transition Temperature

The glass transitions (Tg) of the polymers are measured with equipment able to realize a thermo mechanical analysis. A RDAII “RHEOMETRICS DYNAMIC ANALYSER” proposed by the Rheometrics Company has been used. The thermo mechanical analysis measures precisely the visco-elastics changes of a sample in function of the temperature, the strain or the deformation applied. The apparatus records continuously, the sample deformation, keeping the stain fixed, during a controlled program of temperature variation. The results are obtained by drawing, in function of the temperature, the elastic modulus (G′), the loss modulus and the tan delta. The Tg is highest temperature value read in the tan delta curve, when the derived of tan delta is equal to zero.

Molecular Weight

The mass average molecular weight (Mw) of the polymers is measured with by size exclusion chromatography (SEC). Polystyrene standards are used for calibration. The polymer is dissolved in THF at a concentration of 1 g/L. The chromatography column uses modified silica. The flow is 1 ml/min and a detector if refractive index is used.

Particle Size Analysis

The particle size of the primary particles after the multistage polymerization is measured with a Zetasizer with dynamic lightscattering. As result the weight average particle size (diameter) is taken.

The particle size of the polymer powder after recovering is measured with Malvern Mastersizer 3000 from MALVERN with laser diffraction.

For the estimation of weight average powder particle size, particle size distribution and ratio of fine particles a Malvern Mastersizer 3000 apparatus with a 300 mm lenses, measuring a range from 0.5-880 μm is used.

Porosity

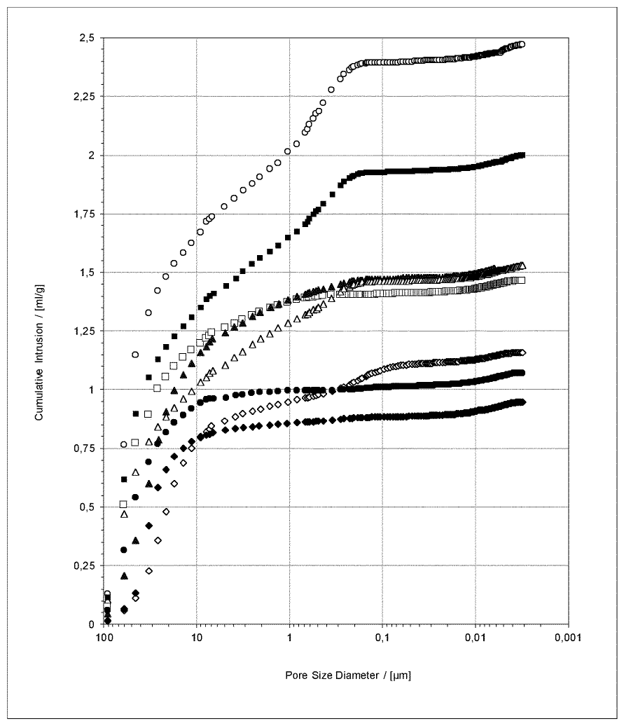

The porosity is measured as cumulative intrusion of mercury into the porous structure. The norm ISO 15901-1:2016 called “Evaluation of pore size distribution and porosity of solid materials by mercury porosimetry and gas adsorption—Part 1: Mercury porosimetry” is used. As equipment an AutoPore™ IV model 9500 from the company Micromeritics® is used. As one result the cumulative intrusion as function of pore size diameter is obtained as shown in FIG. 1.

Dispersion test, a sample of the respective powder is dispersed in a liquid composition. The results of dispersion test are given in ++ and − symbols. This signifies how fast and easy the powder dispersed in a liquid composition. A − symbol signifies bad dispersion, the powder maybe still separated after the dispersion test either floating, sinking or other phase separation. A + or ++ symbol signifies good instantly dispersion or a very good instantly dispersion. In the examples, the monomer methyl methacrylate (MMA) is used as liquid composition. In a glass recipient containing 99 g of MMA at 25° C. is added 1 g of the respective powder. The mixture is observed after 60 s if the powder is dispersed or not, without stirring.

Apparent Density

The norm ISO 60:1977 is used. The sample is poured through a specified funnel into a measuring cylinder of 100 cubic centimeter capacity, the excess is removed with a straightedge and the mass of the contents is determined by weighing.

Viscosity

The viscosity can be easily measured with a Rheometer or viscosimeter. The dynamic viscosity is measured at 25° C. If the liquid has a Newtonian behaviour, meaning no shear thinning, the dynamic viscosity is independent of the shearing in a rheometer or the speed of the mobile in a viscometer. If the liquid composition has a non-Newtonian behaviour, meaning shear thinning, the dynamic viscosity is measured at a shear rate of 1 s⁻¹ at 25° C.

### Examples

The following polymer powders were tested:

Comparative example 1: a powder made of a core/shell polymer with a butadiene core and a (meth)acrylic shell is used. The product has a total intruded volume of 0.945 ml/g and is shown by diamonds (full symbol) in FIG. 1. In FIG. 1 the intrusion of mercury in ml/g is shown as function of the pore size diameter in μm. The intruded volume is cumulated and the total intruded volume is the volume at the smallest pore diameter.

Comparative example 2: a MBS core-shell powder is used. The product has a total intruded volume of 1.07 ml/g and is shown by circles (full symbol) in FIG. 1.

Comparative example 3: a powder called EXL2691A from Rohm and Haas Company is used. The product has a total intruded volume of 1.16 ml/g and is shown by diamonds (open symbol) in FIG. 1.

Example 1: A MBS core-shell powder having a total intruded volume of 1.46 ml/g and is shown by squares (open symbol) in FIG. 1.

Example 2: A MBS core-shell powder having a total intruded volume of 1.53 ml/g and is shown by triangles (open symbol) in FIG. 1.

Example 3: A MBS core-shell powder having a total intruded volume of 1.51 ml/g and is shown by triangles (full symbol) in FIG. 1.

Example 4: A MBS core-shell powder having a total intruded volume of 2.02 ml/g and is shown by squares (full symbol) in FIG. 1.

Example 5: A MBS core-shell powder having a total intruded volume of 2.47 ml/g and is shown by circles (open symbol) in FIG. 1

TABLE 1
Respective Powder Characteristics - Particle
size and particle size distribution

| | D10 | D50 | D90 |
|---|---|---|---|
| | [μm] | [μm] | [μm] |
| Comparative | 60 | 140 | 260 |
| Example 1 | | | |
| Comparative | 160 | 800 | 2000 |
| Example 2 | | | |
| Comparative | 30 | 100 | 250 |
| Example 3 | | | |
| Example 1 | 90 | 350 | 880 |
| Example 2 | 50 | 150 | 650 |
| Example 3 | 30 | 80 | 160 |
| Example 4 | 43 | 85 | 215 |
| Example 5 | 40 | 80 | 200 |

FIG. 1 shows the cumulative intrusion as function of pore size diameter for the respective samples. The cumulative intrusion of mercury in ml/g is given for a pore size diameter between 100 μm and 0.003 μm. Results are given in table 2 for total intruded volume, bulk density and the dispersion test of the respective samples.

The date in FIG. 1 is further elaborated in certain increments of pore diameters. This date is show, in tables 3 and 4.

TABLE 2
Results from Mercury Porosity and dispersion test

| | total | | |
|---|---|---|---|
| | intruded | Bulk | |
| | volume | density | Dispersion |
| | [ml/g] | [g/cm³] | Test |
| Comparative | 0.945 | 0.498 | − |
| Example 1 | | | |
| Comparative | 1.07 | 0.419 | − |
| Example 2 | | | |
| Comparative | 1.16 | 0.433 | − |
| Example 3 | | | |
| Example 1 | 1.46 | 0.362 | + |
| Example 2 | 1.53 | 0.334 | + |
| Example 3 | 1.51 | 0.422 | + |
| Example 4 | 2.02 | 0.271 | ++ |
| Example 5 | 2.47 | 0.248 | ++ |

TABLE 3
Results from Mercury Porosity

| | Relative | | | |
|---|---|---|---|---|
| | incremental | Incremental | Relative | incremental |
| | intrusion for | intrusion for | incremental | intrusion for |
| | a pore volume | a pore volume | intrusion for | a pore volume |
| | >10 μm | >10 μm | a pore volume | 10 μm-1 μm |
| | [%] | [ml/g] | 10 μm-1 μm [%] | [ml/g] |
| Comparative | 83 | 0.78 | 6 | 0.078 |
| Example 1 | | | | |
| Comparative | 86 | 0.93 | 6 | 0.075 |
| Example 2 | | | | |
| Comparative | 66 | 0.77 | 14 | 0.15 |
| Example 3 | | | | |
| Example 1 | 80 | 1.18 | 14 | 0.19 |
| Example 2 | 66 | 1.00 | 18 | 0.26 |
| Example 3 | 75 | 1.15 | 16 | 0.26 |
| Example 4 | 67 | 1.32 | 17 | 0.34 |
| Example 5 | 66 | 1.64 | 16 | 0.38 |

TABLE 4
Results from Mercury Porosity

| | Relative | | Relative | |
|---|---|---|---|---|
| | incremental | incremental | incremental | incremental |
| | intrusion | intrusion | intrusion | pore volume |
| | for a pore | for a pore | for a pore | intrusion |
| | volume | volume | volume | for a |
| | 10 μm-0.1 μm | 10 μm-0.1 μm | 1 μm-0.01 μm | 1 μm-0.01 μm |
| | [%] | [ml/g] | [%] | [ml/g] |
| Comparative | 14 | 0.13 | 5 | 0.05 |
| Example 1 | | | | |
| Comparative | 7.4 | 0.08 | 1.4 | 0.015 |
| Example 2 | | | | |
| Comparative | 27 | 0.31 | 11.4 | 0.13 |
| Example 3 | | | | |
| Example 1 | 16 | 0.23 | 4 | 0.05 |
| Example 2 | 29 | 0.45 | 12 | 0.18 |
| Example 3 | 21 | 0.31 | 5 | 0.075 |
| Example 4 | 31 | 0.61 | 15 | 0.30 |
| Example 5 | 30 | 0.74 | 15 | 0.37 |

The tables 3 and 4 show, that additionally to a total intruded volume of at least 1.2 ml/g, it is also important to have an incremental intrusion for a pore volume above 10 μm of at least 0.9 ml/g, for a pore volume from 10 μm-1 μm of at least 0.15 ml/g, for a pore volume from 10 μm-0.1 μm of at least 0.2 ml/g and for a pore volume from 1 μm-0.01 μmf at least 0.05 ml/g.

The powder composition examples according to the invention are much faster dispersed in the monomer MAM, than the comparative powder examples, as shown in last column of table 2.

1. A polymeric composition in form of a porous polymer powder POW1 having a total intruded volume of at least 1.2 ml/g as measured by mercury porosimetry.

2. The polymeric composition according to claim 1, wherein the total intruded volume is at least 1.35 ml/g as measured by mercury porosimetry.

3. The polymeric composition according to claim 1, wherein the total intruded volume is at most 10 ml/g as measured by mercury porosimetry.

4. The polymeric composition according to claim 1, wherein the total intruded volume is between 1.2 ml/g and 10 ml/g.

5. The polymeric composition according to claim 1 having an relative incremental intrusion for a pore size above 10 μm of at most 85%.

6. The polymeric composition according to claim 1 having an incremental intrusion between a pore size from 10 μm to 1 μm of at least 0.1 ml/g.

7. The polymeric composition according to claim 1 having an incremental intrusion between a pore size from 10 μm to 0.1 μm of at least 0.15 ml/g.

8. The polymeric composition according to claim 1 having a relative incremental intrusion between a pore size from 10 μm to 1 μm of at least 5%.

9. The polymeric composition according to claim 1 wherein the porous polymer powder POW1 has a volume median particle size D50 between 1 μm and 700 μm.

10. The polymeric composition according to claim 1 wherein an apparent bulk density of the polymer powder POW1 is between 0.1 g/cm³ and 0.60 g/cm³.

11. The polymeric composition according to claim 1 wherein the polymer powder POW1 comprises polymeric particles PAR1 that make up at least 50 wt % of the polymer powder POW1.

12. The polymeric composition according to claim 11, wherein the polymeric particles PAR1 have a weight average particle size (diameter) between 15 nm and 900 nm.

13. The polymeric composition according to claim 1 wherein the polymeric particle PAR1 is a multistage polymer MSP1 in a form of core-shell particles.

14. The polymeric composition according to claim 11 wherein the polymer powder POW1 comprises a multistage polymer MSP1 in a form of a core-shell particle and a (meth)acrylic polymer MP1 in a form of a polymeric particles.

15. The polymeric composition according to claim 11 wherein the polymer powder POW1 comprises a polymer P1.

16. The polymeric composition according to claim 13 wherein the multistage polymer MSP1 has a multilayer structure comprising at least one stage (SA1) comprising a polymer (A1) having a glass transition temperature below 10° C., and at least one stage (SA2) comprising a polymer (A2) having a glass transition temperature over 60° C.

17. The polymeric composition according to claim 1 wherein the polymer powder POW1 comprises a multistage polymer MSP1 and a (meth)acrylic polymer MP1.

18. A process for manufacturing a liquid polymer composition LCP1 comprising the steps of:
a) providing the polymeric composition in form of a porous polymer powder POW1 having a total intruded volume of at least 1.2 ml/g as measured by mercury porosimetry according to claim 1, and
b) bringing into contact said polymeric composition in form of said porous polymer powder POW1 with a liquid composition LC1.

19. The process according to claim 18, wherein a viscosity of the liquid composition LC1 is between 0.5 mPas 1000 Pa*s at a temperature of 25° C.

20. The process according to claim 18 wherein the liquid composition LC1 is chosen from compositions for preparing vinyl esters, unsaturated polyesters or epoxy resins; styrenic monomers, (meth)arylic monomers, and mixtures thereof.

21. The process according to claim 18 wherein the pourous polymer powder POW1 represents between 0.5 and 50 wt % of the liquid polymer composition LCP1.

22. (canceled)

23. A process to reduce the dispersing time of a polymer powder in a liquid by providing a polymeric composition in form of a porous polymer powder POW1 having total intruded volume of at least 1.2 ml/g as measured by mercury porosimetry according to claim 1.

24. The process according to claim 23, comprising the steps of:
providing a precursor for a thermosetting polymer or a monomer of a thermoplastic polymer; and
bringing into contact the polymeric composition in form of said porous polymer powder POW1 and said precursor.

25. The process according to claim 24, wherein the precursor is liquid, having a viscosity of the liquid composition LC1 between 0.5 mPas 1000 Pa*s at a temperature of 25° C.

26. The process according to claim 24, wherein between 0.5 parts by weight and 100 parts by weight of porous polymer powder POW1 are brought into contact for 100 parts by weight of said precursor.

27. (canceled)
